(19) United States
(12) Patent Application Publication
(10) Pub. No.: US 2005/0061538 A1
(43) Pub. Date: Mar. 24, 2005

(54) High voltage electrical power transmission cable having composite-composite wire with carbon or ceramic fiber reinforcement

(76) Inventor: Joseph T. Blucher, 46 Hillcrest Road, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/498,687

(22) PCT Filed: Dec. 12, 2001
(86) PCT No.: PCT/US01/48758

(51) Int. Cl. H01B 5/00

(52) U.S. Cl. 174/126.2

(57) ABSTRACT

A high power electrical transmission cable having composite wires (10), wherein the wires have aligned reinforcing fibers (12) of carbon or ceramic embedded within a matrix material (14). A jacket of an electrically conductive material surrounds the core wire (10). The reinforcing fibers and the matrix material may be also electrically conducting materials. The matrix material may be aluminum, copper, a polymer, or an epoxy material.

### CROSS REFERENCE TO RELATED APPLICATIONS

N/A

### STATEMENT REGARDING FEDERALLY SPONSORED RESEARCH OR DEVELOPMENT

### BACKGROUND OF THE INVENTION

High power electrical transmission cables are required for transmission of electrical power between power generating stations. Such cables typically have a reinforcing or supporting core wire made of steel. The steel core carries the load of the cable. Strands of an electrically conducting material are wound around the steel core. The strands are typically formed from aluminum or copper.

In cables having a steel core, the steel has a relatively high specific weight (7.8 gm/cc). Also, steel has a large coefficient of thermal expansion that can result in sagging of the cable. In extreme cases, thermal expansion can cause the cable to break. Another disadvantage arises from the use of a single load-carrying cable; failure of this single cable can be catastrophic to the entire cable.

In PCT International Publication No. WO 97/00976, a high power transmission cable is disclosed having a composite material core. This cable is stronger, more lightweight, and has a lower thermal expansion coefficient than cables using a steel core. The core material, however, has an elongation of only 1 to 1.5% and is relatively brittle, leading to possible breakage and failure of the cable.

### SUMMARY OF THE INVENTION

The present invention provides a high power electrical power transmission cable that is strong, lightweight and has a lower coefficient of thermal expansion. The cable is formed from composite-composite wires that comprise individual strands of a conducting material such as aluminum or copper in concentric or random arrangement with one or more cores of ceramic or carbon fiber reinforced composite wire. The composite core wire comprises aligned reinforcing fibers of carbon or ceramic embedded within a matrix material. Preferably, the matrix material is also a conducting material, such as aluminum or copper, although other materials can be used.

The composite core wire may be formed by a continuous pressure infiltration process such as that disclosed in U.S. Pat. No. 5,736,199, the disclosure of which is incorporated by reference herein. The concentric jacketing of the composite core wire(s) with the conducting material can be carried out in a number of ways. For example, the jacketing materials may be coextruded over the composite core wire(s). The jacketing material may be cold rolled longitudinally around and along the composite core wire(s). Alternatively, the composite core wire(s) may be inserted in a tube of the jacketing material, which may be drawn down over the composite core wire(s). Other methods of jacketing the composite core wire are possible.

### DESCRIPTION OF THE DRAWINGS

The invention will be more fully understood from the following detailed description taken in conjunction with the accompanying drawings in which:

FIG. 1 is a copy of a micrograph at 1000× illustrating the composite core wire of the present invention;

FIG. 2 is a copy of a micrograph at 30× illustrating a composite-composite wire comprising the composite core wire of FIG. 1 jacketed with a copper jacket;

FIG. 3 is a copy of a micrograph at 450× more closely depicting the interface between the composite core wire and the copper jacket of FIG. 2; and

FIG. 4 is a schematic illustration of a plurality of composite core wires within a jacket.

### DETAILED DESCRIPTION OF THE INVENTION

According to the present invention, a high power electrical transmission cable is formed from composite-composite wires, each composite-composite wire comprising individual strands of a conducting material such as aluminum or copper in concentric, even, or random arrangement with one or a plurality of cores of ceramic or carbon fiber reinforced composite wire.

The composite core wire comprises aligned reinforcing fibers of carbon or ceramic embedded within a matrix material. Carbon fibers are preferred, because carbon is conductive and generally less expensive than ceramics. However, any suitable ceramic fiber, such as aluminum oxide, may be used if desired. Preferably, the matrix material is also a conducting material, such as aluminum or copper, although other materials can be used. For example, a polymer or epoxy material can be used for the matrix. Such a material is less conductive than, for example, aluminum or copper, but provides the same or similar strength and may be less expensive to manufacture.

The composite core wire may be formed by a continuous pressure infiltration process such as that disclosed in U.S. Pat. No. 5,736,199, the disclosure of which is incorporated by reference herein. In this process, strands of carbon or ceramic fibers are introduced into a pressurized bath of molten matrix material through a lower orifice which provides a gradient such that the matrix material is liquid adjacent to the bath and solid farthest from the bath, thereby preventing the pressurized molten matrix material from blowing out of the bath. In the pressurized bath, the matrix material infiltrates the fibers. The infiltrated fibers are drawn upwardly out of the bath into a pressurized environment in which the molten matrix material solidifies. Then the infiltrated, solidified core wire is drawn through an exiting orifice to an ambient environment. Using this continuous process, great lengths of composite core wire, suitable for use in power transmission cables, can be manufactured.

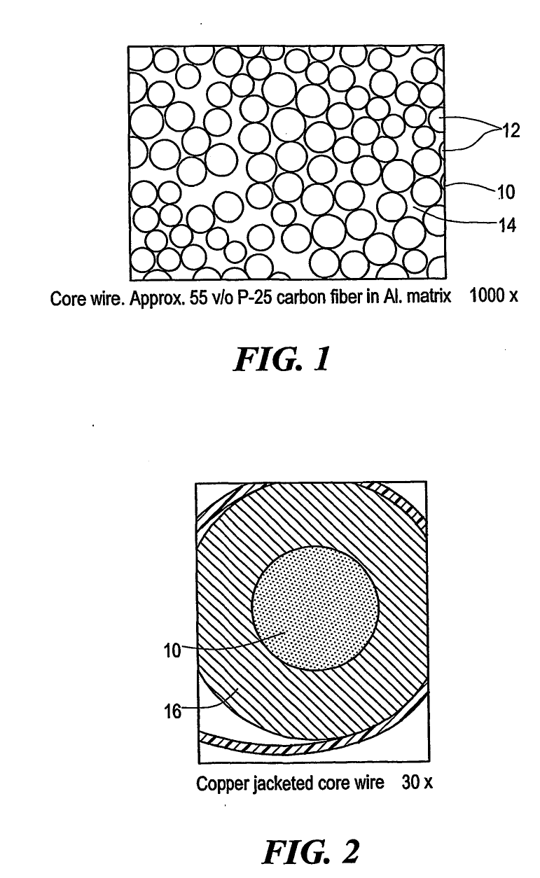

FIG. 1 illustrates a composite core wire 10 of carbon fibers 12 in an aluminum matrix 14. In this example, the composite core wire comprises approximately 12,000 individual strands of carbon or ceramic fiber. The solidified, infiltrated core wire has a diameter of approximately 1/16 inch. However, the number of strands of the fiber material and the finished diameter of the composite core wire may be chosen depending on the desired finished composite-composite wire, which depends on the power, voltage, and distance of the desired power transmission cable. Over long distances, power is usually transmitted at high voltages, at least 22 kV and often much greater.

If a polymer material is used for the matrix, the same continuous pressure infiltration process may be used, although the pressure required to cause the polymer matrix material to infiltrate the fibers may be lower than is required for a metal such as aluminum or copper.

The jacketing of the composite core wire or wires with the conducting material can be carried out in a number of ways. For example, the jacketing material may be coextruded over the composite core wire or wires. Alternatively, the jacketing material may be cold rolled longitudinally around and along the composite core wire or wires and welded to seal the longitudinal joint. In a further alternative, the composite core wire or wires may be inserted in a tube of the jacketing material, which may be drawn down over the composite core wire or wires. It will be appreciated that other methods of jacketing the composite core wire are possible. The core wire or wires may be concentrically or evenly or randomly distributed within the jacketing material. The jacketed core wire may then be covered with any suitable insulating material and any other desired sheathing, as known in the art.

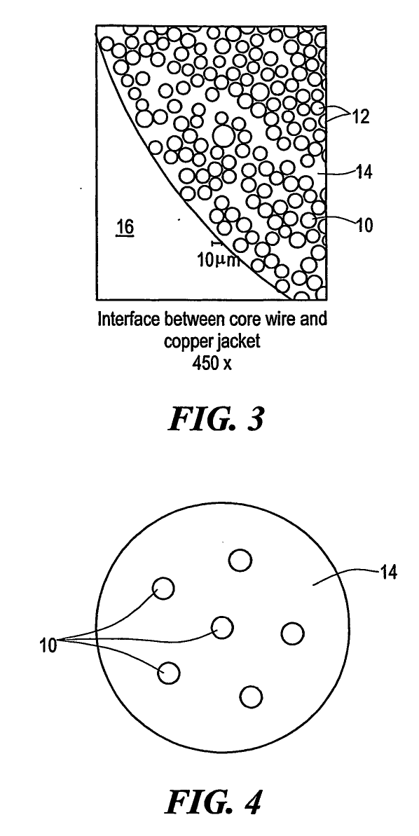

FIG. 2 illustrates one composite core wire 10 of FIG. 1 jacketed in a copper wire 16. FIG. 3 illustrates the interface between the composite core wire and the copper jacket of FIG. 2. FIG. 4 illustrates a plurality of composite core wires 10 in a random distribution within a jacket 14.

Strands of copper cable having carbon fibers and strands having aluminum oxide fibers were produced using the above-described high pressure, continuous infiltration process. The tensile strengths of the strands were above 50,000 psi, which is about 2.5 times that of pure copper. The weight of the reinforced strands was about 20 percent lower than that of pure copper.

A number of composite-composite reinforced wires formed in this manner can be assembled into a suitably sized power transmission cable in any desired manner. The composite-composite reinforced wires are relatively light in weight, having a specific weight ranging from 2.1 to 2.7 gm/cc, thereby leading to considerable weight savings over existing power transmission cables. The composite-composite reinforced wires also have relatively high strength and a low coefficient of thermal expansion.

The invention is not to be limited by what has been particularly shown and described, except as indicated by the appended claims.

1. A high power electrical transmission cable comprising:
a composite core wire comprising aligned reinforcing fibers of carbon or ceramic embedded within a matrix material; and
a jacket of an electrically conductive material surrounding the core wire.

2. The cable of claim 1, wherein the reinforcing fibers comprise aluminum oxide.

3. The cable of claim 1, wherein the reinforcing fibers are electrically conductive.

4. The cable of claim 1, wherein the matrix material comprises an electrically conductive material.

5. The cable of claim 1, wherein the matrix material comprises aluminum or copper.

6. The cable of claim 1, wherein the matrix material comprises a polymer or an epoxy.

7. The cable of claim 1, wherein the tensile strength of the fibers is greater than 50,000 psi.

8. The cable of claim 1, wherein the cable has a specific weight ranging from 2.1 to 2.7 gm/ cc.

9. The cable of claim 1, further comprising a plurality of composite core wires, each composite core wire comprising aligned reinforcing fibers of carbon or ceramic embedded within a matrix material, the jacket surrounding the further composite core wire.

10. The cable of claim 9, wherein the plurality of composite core wires are evenly distributed within the jacket.

11. The cable of claim 9, wherein the plurality of composite core wires are randomly distributed within the jacket.

12. The cable of claim 1, wherein the composite core wire is concentric with the jacket.

13. The cable of claim 1, wherein the core wire is sized to transmit at least 22 kV.

14. The cable of claim 1, further comprising an insulating sheath concentrically surrounding the jacket.
